(19) United States
(12) Patent Application Publication
(10) Pub. No.: US 2006/0106802 A1
(43) Pub. Date: May 18, 2006

(54) Stateless methods for resource hiding and access control support based on URI encryption

(75) Inventors: Christopher J. Giblin, Zurich (CH); Tadeusz J. Pietraszek, Adliswil (CH); James F. Riordan, Rueschlikon (CH); Chris P. Vanden Berghe, Zurich (CH)

Correspondence Address: Gail Zarick;IBM Corporation, Intellectual Property Law Dept., P.O. Box 218, Yorktown Heights, NY, 10598, US

(73) Assignee: International Business Machines Corporation, Armonk, NY (US)

(21) Appl. No.: 10/991,580

(22) Filed: Nov. 18, 2004

(51) Int. Cl. G06F 7/00; G06F 17/30

(52) U.S. Cl. 707/9

(57) ABSTRACT

An apparatus and method are disclosed for enabling controlled access to resources at a resource provider server. The invention may encrypt or decrypt a portion of a uniform resource identifier (URI), according to a stateless method for hiding resources and/or providing access control support. Upon receipt of a URI having an encrypted portion, the invention decrypts the encrypted portion using a predetermined key to obtain a decrypted segment, extracts additional information from the decrypted segment and forms a decrypted URI, before the decrypted URI is forwarded to a resource producer server. The invention may also encrypt a URI from a resource provider server before it is sent to a client in response to a client request.

### BACKGROUND OF THE INVENTION

The present invention relates to information retrieval in a computer network and more particularly to a method of controlling access and hiding the structure of resources on websites.

The World Wide Web, like many applications in the Internet, employs a client/server model to deliver a wealth of information to a requesting end user. Web servers disseminate information in the form of Web pages. Each Web page is associated with a special identifier called a Uniform Resource Identifier (URI). A Uniform Resource Locator (URL) is a specific type of URI which identifies a network path to the server, i.e., a URL specifies the location of a resource. The URL is a special syntax identifier defining a communications path to specific information. Each logical block of information accessible to a client, called a “page” or a “Web page,” is identified by a URL. The URL provides a universal, consistent method for finding and accessing this information, primarily for a user's Web browser. A browser is a program capable of submitting a request for information to a data source or server, such as a data source identified by a URL at a client machine. An end user may use one of many different browser applications in order to view Web pages and may initiate a request by clicking or otherwise activating a hyperlink (link), button, or other device on a Web page displayed by the client. The user may also initiate a request by entering a URL in the entry field of the browser. The request includes the URL identifying a resource located on a web application server, but it may also include other information to identify the client or the nature of the request.

Communication between a web client's web browser and an e-commerce web site is based on HTTP (HyperText Transfer Protocol), a well-known protocol for handling the transfer of various data files such as text, still graphic images, audio, motion video, etc. HTTP is a stateless protocol, meaning that information about a web client is not maintained from one request to the next.

Web-based applications are responsible for maintaining state across a series of associated requests from a client. Such state is called a session. Session management allows a web site to remember a web client between different requests. Typically, session information is written in “cookies” or in hidden form fields or is stored in URLs using a technique known in the art as URL rewriting. A “cookie” is a data object transported in variable-length fields within headers of Hypertext Transfer Protocol (“HTTP”) request messages (used when requesting objects) and response messages (used when providing the requested objects). Cookies are normally stored on the client, either persistently or for the duration of a session, e.g., for the duration of a customer's electronic shopping interactions with an on-line merchant. A cookie stores certain data that the server application wants to remember about a particular client. This could include client identification, session parameters, user preferences, session state information, etc., as those who are skilled in the art will recognize.

A content provider may wish to prevent others from filtering out, tailoring or tampering with the content of web pages that are served to them, or from extracting or aggregating desired content. For example, by filtering on URI patterns, users may block out certain types of content, such as advertisements, that support the cost of providing informational web pages to users who visit a website. For this method of underwriting costs to have integrity, the provider's content must be viewed.

Web servers may make use of sessions to vary the contents of web pages identified by the same URL depending on the server's internal state. While sessions can be used to control access to websites, however, the server must maintain the state of all the sessions. It may not be feasible for a server to do this for certain applications because session data has to be stored on the server for the duration of the session. Cookies may be used to perform sessionless access control, but they cannot be relied on in all cases as a primary means for maintaining application state information across many types of Web transactions. For one thing, cookies are stored and retrieved on the web client's computer or other client device. Certain client devices, however, may be incapable of storing cookies. These include wireless pervasive devices (such as Webphones, personal digital assistants or “PDAs,” etc.), which may access the Internet through a Wireless Application Protocol (“WAP”) gateway using the Wireless Session Protocol (“WSP”). WSP does not support cookies. Also, a cookie-based system does not enable sessionless access control in situations wherein it may be desirable to share or transmit a URL from one entity to another. In a cookie-based system, certain resources are not identified merely by a URL but rather by a pair consisting of a URL and a cookie. Because of this pairing of URLs and cookies, sessionless access to a particular resource cannot be easily be granted by simply sharing or communicating a URL electronically from one party to another.

The Applicants therefore believe that there is a need for a stateless method of hiding resources and/or controlling access to resources on websites.

### BRIEF SUMMARY OF THE INVENTION

The present invention improves on the prior art and eliminates many problems associated with the prior art including, but not limited to, those previously discussed above. Objects and advantages of the invention are achieved by the features of the claims set forth below.

The invention provides a method and apparatus for providing controlled access to resources at a resource provider server in response to a resource request from a client, wherein the resource request comprises a uniform resource identifier (URI) having an encrypted portion. The inventive method decrypts the encrypted portion using a predetermined key to obtain a decrypted segment. Additional information is extracted from the decrypted segment, and the additional information is verified. This additional information may be data supporting integrity, access control, session management and/or application specific purposes. The method derives a decrypted URI with at least a portion of the decrypted segment and forwards the decrypted URI to a resource producer server.

The inventive method may also include receiving, from a resource producer server, a resource responsive to the request. The resource may comprise one or more unencrypted URIs having a transparent segment and an opaque segment. The method may encrypt at least a portion of the opaque segment and may form an encrypted URI with the transparent segment and the encrypted portion. The encrypted URI may then be forwarded to the client.

In another aspect, the invention is directed to a method of providing a service enabling controlled access to an external resource producer server. According to this aspect, in response to a request from a client for access to a resource, the invention determines whether one or more transactional requirements are satisfied, and, if so, the method creates a uniform resource identifier (URI) responsive to the request. The URI includes predetermined data and a predetermined structure. The invention also encrypts at least a portion of the URI and sends the URI with the encrypted portion in response to the request. The client is thus enabled to gain access to the external resource producer server, which may be a separate entity from the service provider that provides the URI with the encrypted information.

In other aspects, the invention may be embodied as a computer program product or a program storage device readable by machine, tangibly embodying a program of instructions executable by the machine to perform the inventive methods described above.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flowchart illustrating a preferred embodiment for encoding a portion of a URI according to the invention;

FIG. 2 is a flowchart illustrating a preferred embodiment for decoding a portion of a URI according to the invention; and

FIG. 3 illustrates schematically how a preferred embodiment of the invention may function.

FIG. 4 illustrates another preferred embodiment characterizing the invention as a service.

### DETAILED DESCRIPTION OF THE INVENTION

A number of preferred embodiments of the present invention will now be described. The following is intended to provide a detailed description of an example of the invention and should not be taken to be limiting of the invention itself. Rather, any number of variations may fall within the scope of the invention which is defined in the claims following the description.

Preliminarily, some known aspects of Uniform Resource Identifiers (URIs) and their structures will be explained in order to aid in describing the invention. As is known in the art, a URL is a type of URI that identifies a resource via a representation of its network location. A URI is a compact string of characters that provides an extensible means for identifying resources on the web. The syntax and semantics of URIs are specified in RFC 2396, a specification published by the Internet Engineering Task Force (IETF) at http://www.ietf.org. The RFC 2396 specification defines a generic syntax for all URIs. In the description that follows, we discuss URLs as an example of resource identifiers to which the method of the invention is addressed. Although the “http:” URI scheme will be used by way of example, the invention may also be applied to other schemes such as ftp, nfs, afs, dav, mailto, rtsp, pnm, soap.beep, etc. The format for different schemes is set forth in various specifications, an official list of which is maintained by the Internet Assigned Numbers Authority (IANA). The IANA registry of URI schemes is available on the Web at <http://www.iana.org/assignments/uri-schemes>.

In the case of http, the format for this scheme is described in the IETF specification RFC2616 (available on the Web at

<http://www.ietf.org/rfc/rfc2616.txt>). That is. for http the
structure <scheme>:<scheme-specific-part> is specified as:
http://<host>[:<port>] [<abs_path>[?<query>] ]

where <host> refers to a domain name of a network host or its IP address, as is known in the art; and <port> refers to the network port number for the server. The <abs_path> portion refers to an absolute-path reference, which may be a relative reference beginning with a single slash character (“/”), and the <query> component is a string of information that is to be interpreted by the resource. Parts marked with [ ] are not obligatory.

For each protocol there is a corresponding URI syntax. These protocol specific definitions have in common the fact that they consist of a part that is necessarily transparent and a part that can be opaque, i.e., it needs to be understood only by the server. In the case of HTTP, the transparent part is http://<host>[:<port>] and contains the protocol, host and port, as they are needed to deliver the request to the hosting server. The rest of the URI, e.g., [<abs_path>[?<query>]] for the http scheme, may be referred to as the opaque part, as it is not needed for correctly delivering the request and is interpreted only by the hosting server.

Thus, a URI has a hierarchical structure that may be human readable, although the resource part of the structure, e.g., the query component, typically corresponds to a directory structure on the server where the resource may be located. A set of URIs or hyperlinks to web pages indicating a directory structure and resources that correspond thereto may appear in the form of, for example,

http://www.site.com/resources/2004/paper2.pdf
http://www.site.com/adv/images/cjdfrwe.jpg
http://www.site.com/pages/page2.html

As illustrated by the above examples, the hierarchical structure of a resource may be evident because the URI is human readable.

The present invention provides a method and computer implemented instructions to provide stateless resource hiding and support of access control for websites, based on encryption of URIs. The method uses stateless dynamic URI rewriting, combined with cryptographic measures. According to the invention, a method is provided in which the opaque part of a URI may be encrypted by a server. In the case of http, for example, the method provides for encryption of at least a portion of the <abs_path>, the <query> and/or possibly additional information.

In the description ofthe invention that follows, we use the http URI scheme as an example. Those of skill in the art will recognize that our method may be used together with all URI schemes that contain an opaque part (e.g. ftp. nfs. afs. dav. mailto, rtsp, pnm, soap.beep, etc.).

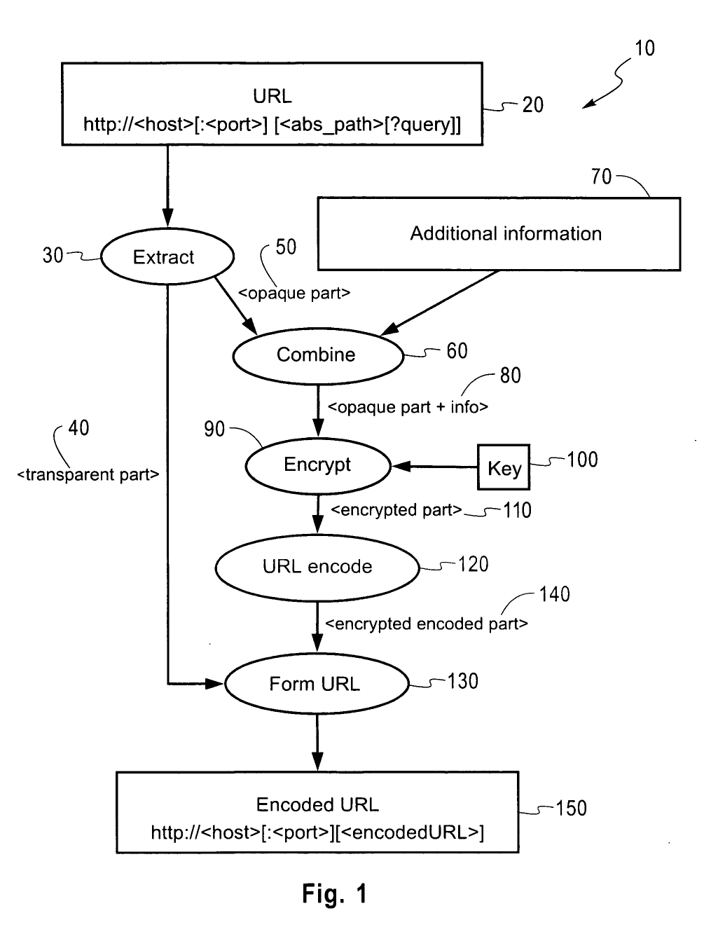

With reference now to the figures, FIG. 1 depicts a flowchart for a method of encoding at least a portion of a URI in accordance with a preferred embodiment of the invention. As shown in FIG. 1, the method (10) begins by receiving a URI (20), as exemplified by the URL syntax http://<host>[:<port>][<abs_path>[?query]]. The URI (20) is split or extracted (30) into transparent part (40) and opaque part (50). According to the example URI in (20), the transparent part (or <transparent part>) (40) may be represented as http://<host>[:<port>], and the opaque part (50) may be represented as [<abs_path>[?<query>]]. As indicated in block (60). the opaque part (50) may be combined with additional information (70), which may comprise, for example, a client's Internet Protocol (IP) address, timestamp, time-to-live, magic number, nonce, sequence counter, hash value, means to ensure integrity, or other application specific information, etc., as those of skill in the art will recognize. The combination of opaque part (50) and additional information (70) preferably results in a writing of (50) and (70) in a standardized string format, referred to in FIG. 1 as <opaque part+info> (80).

The <opaque part+info> (80), or some portion thereof, may be encrypted using an encryption algorithm (90) and using an encryption key (100) to form <encrypted part> (110). A person having skill in the art will recognize that use of any one of many industry standard or non-standard encryption algorithms may be used to encrypt all or a portion of the string of characters in <opaque part+info> (80). While the entire string <opaque part+info> may be encrypted in order to hide resources and other support information in the URI (which will be discussed later), the method of the invention may encrypt some portion of this part of the URI.

The <encrypted part> (110) may be URI-encoded (120) to form <encoded encrypted part> (140). URI encoding (120) ensures that the encrypted part (110) is syntactically correct and that it conforms to URI specifications; for example, block (120) encodes characters that should not be in the URI. In block (130), <encoded encrypted part> (140) is combined with <transparent part> (40) to construct a URI (150) that is encoded as desired. Accordingly, as illustrated by way of example in FIG. 1, a URI is encoded from a structure that appears as http://<host>[:<port>[<abs_path>[?query]] as in block (20) to a structure that appears as http://<host>[:<port>][<encodedURL>] in block (150). More generally, for any URI represented as <scheme>:<scheme-specific-part>, the method of the invention as described with reference to FIG. 1 may encrypt one or more portions of <scheme-specific-part>.

The method of the invention therefore may effectively hide the path to a resource and/or may allow tamper-resistant adding of arbitrary information to a URI. The additional information may be used, for example, to support access control of the resource, as will be explained in further detail below.

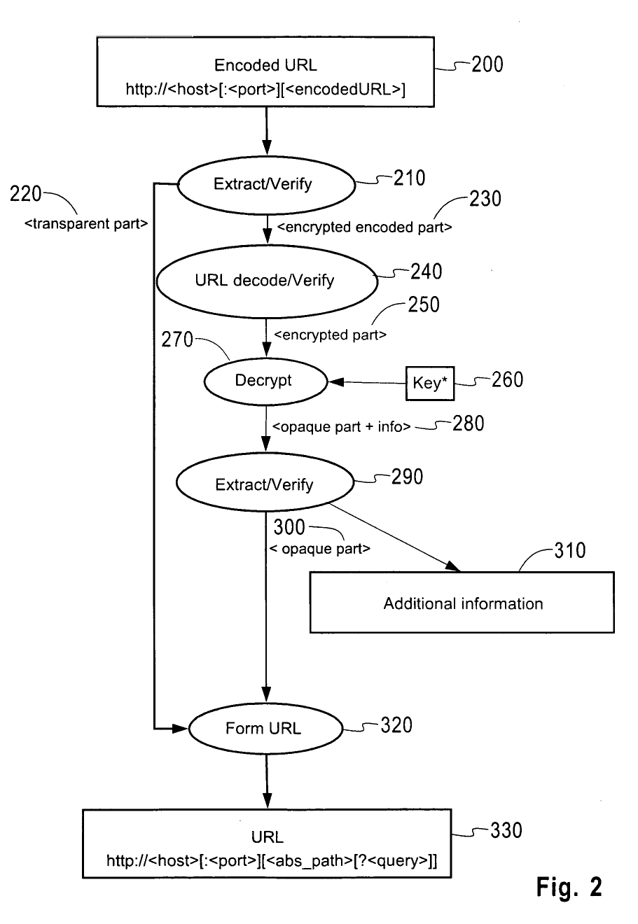

With reference now to FIG. 2, when a server receives a request featuring a URI that has been encrypted as described above, the following procedure may be performed to determine or decode <abs_path>, <query> and/or any additional information that may be encoded therewith. Beginning at block (200), an encoded URI is received, wherein the encoded URI is exemplified by http://<host>[:<port>][<encodedURL>]. It should be noted that the portion referred to here as [<encodedURL>] may be partially or completely encoded.

At block (210), the integrity of the encoded URI may be verified as discussed in further detail below, and the transparent part (220) and opaque part (230) of the encoded URI are extracted. Transparent part (220) in the example of FIG. 2 is exemplified by http://<host>[:<port>], and opaque part (230) is exemplified by <encoded encrypted part> (230). The opaque part (230) is verified and URI-decoded in block (240) to form <encrypted part> (250).

At block (270), <encrypted part> (250) is decrypted using a decryption key (“key*”) (260). The key* (260) is used to decrypt information encrypted by the encryption key (100), which is described above with reference to FIG. 1. Continuing with FIG. 2, the result of the decryption in block (270) is a decrypted portion (280) of a URI, exemplified by <opaque part+info>. At block (290), decrypted portion (280) may be verified as discussed below. Decrypted portion (280) may be split into <opaque part> (300) and any additional information (310) in block (290), wherein additional information (310) may comprise an IP address, timestamp and/or access control information, or other information as described above with respect to additional information (70).

At block (320), both <opaque part> (300) and <transparent part> (220) are used to form a valid URI (330). It should be noted that the URI exemplified by http://<host>[:<port>][<abs_path>[?<query>]] (20) which was encrypted and encoded according to FIG. 1 corresponds to the URI (330) which is decrypted and decoded according to FIG. 2. This URI (330) may be passed to a webserver to retrieve the resource identified in the URI.

In FIG. 2, blocks (210), (240) and/or (290) may additionally perform verification of the URI or a portion thereof to make sure that the string has not been tampered with. For example, verification may include determining whether the resource part of the URI has been selectively changed, by a user for example, or whether the URI has been misused to obtain improper access, or whether certain contents have been extracted or aggregated by an undesired or unauthorized entity such as a robot. Additional information (310) may also contain data to verify the integrity or authenticity of the URI or a portion thereof. For example, additional information (310) may include a magic number, sequence counter or other information as described above with respect to additional information (70). As a person having skill in the art will recognize, a magic number may be used in a variety of ways, such as to indicate whether the decrypted information is in the required or expected form. A sequence counter increases with subsequent requests and is useful in determining the total number of requests.

The URI encryption scheme as presented above may provide resource hiding as well as a tamper-resistant method for adding additional information to a URI. Hiding the path to a requested resource effectively prevents undesired tailoring of web content by means of URI matching through regular expressions. As those of skill in the art will appreciate, regular expressions may be used to describe patterns in a string such as a URI. URIs that have been encrypted according to the invention, however, have no apparent pattern, beyond the hostname portion of the URI, that can be matched and therefore vary with each request; consequently undesired efforts to tailor web content through the use of URI matching are prevented. Examples of undesired tailoring of web content include extraction and aggregation of content and filtering out advertisements.

Tamper-resistant adding of additional information to a URI may serve many purposes. One purpose is to provide support for access control on a requested resource. A time-to-live value added to a URI may be used, for example, to control accessibility of the resource for a limited amount of time. Adding a source-Internet Protocol (IP) address or a range of source-IP addresses to a URI may also be used to control from where the resource can be accessed. In addition, tamperproof URIs prevent probing for other valid URIs since manipulation automatically invalidates the URI. Thus the invention can be employed such that a valid URI can not be modified to produce a different, valid URI.

Advantageously, the method of the invention may be easily implemented at a webserver without changing each web application. The invention is compliant with known client software and Internet infrastructure. Moreover, the method described by the invention is stateless at the server side. This aspect of the invention enables the inventive method to be easy to implement, low in resource-usage, and easy to load balance (because there is no state sharing).

Furthermore, URIs that contain encoded and/or tamper-resistant information according to the inventive method may be easily passed from one entity to another, such as by e-mail, instant messaging, etc., as opposed to prior art methods requiring the use of cookies. Instead of requiring both a URI and a cookie to identify resources (as in a cookie-based system), the method of the invention enables sessionless access control wherein resources are identified merely by the URI that has been encoded and/or combined with tamper resistant information.

Another aspect of the invention pertains to protecting privacy. For example, it is known that network operators and other intermediaries have the ability to record details of all accesses made to servers. Logging of URIs that have been encrypted according to the invention is not effective because the hierarchical, human-readable structure of the URI is converted to a flat, randomized structure which hides and protects certain information that an entity may not wish to expose to others.

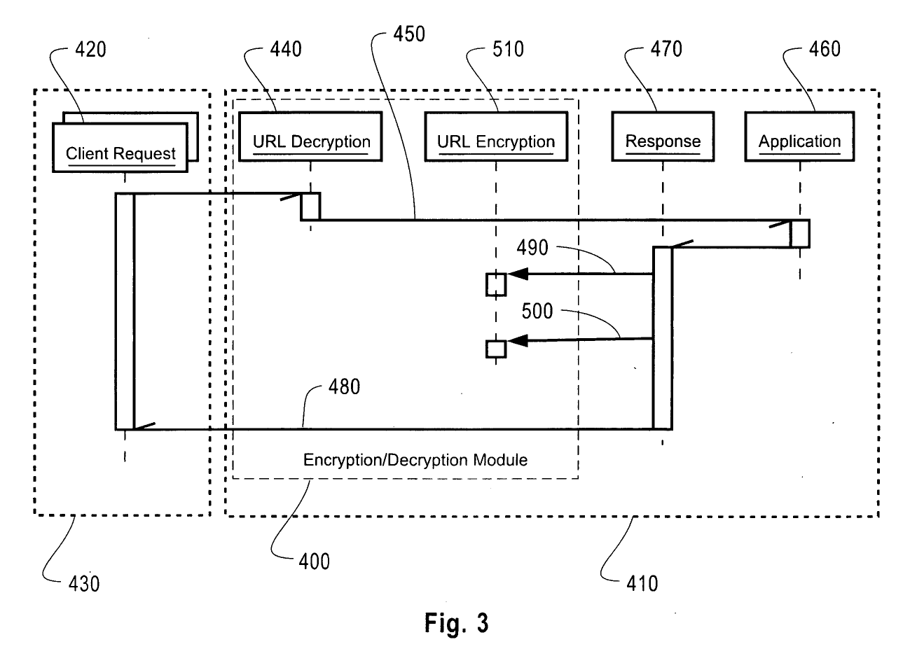

With reference now to FIG. 3, an embodiment of the invention may be implemented as a webserver module (400) which may encrypt and decrypt the URIs, transparent to both a provider and a consumer of the web content.

When a webserver (410) receives a request (420) from a client (430) using an encrypted URI, this URI is decrypted/decoded (440) in accordance with the methods described above with respect to FIG. 2. The decrypted URI may additionally be verified (not shown) and it may be passed along with any additional information (450) to an appropriate handler (460). This handler (460), which may be a web application, may use the additional information for access control or for tailoring the web content. According to this embodiment, the application (460) handling the request does not need to be aware that the inventive URI encryption methods are being performed.

The response (470) created by the handler (460) of the client request (420) may be processed by module (400) in the webserver (410) before it is passed (480) to the requesting client (430). By way of example, a response (470) may be in the form of an HTML page in which one or more URIs are embedded. One or more portions of one or more URIs found in the response (470) may be extracted (490, 500) from the response (470) and encrypted/encoded (510) by module (400), according to a configurable policy, preferably using the methods described above with respect to FIG. 1.

It is to be understood that the terms “URI encryption” and “encrypted URI” are used herein for convenience and brevity to refer to aspects of the methods described above with reference to FIGS. 1 and 2, whereby a URI represented by <scheme>:<scheme-specific-part> may have one or more portions of <scheme-specific-part> encrypted and encoded (FIG. 1), or decrypted and decoded (FIG. 2).

According to an alternative embodiment of the invention, a web application that produces the served content may be made aware of the technique of URI encryption and may encrypt and decrypt desired URIs independent of the webserver. An application may itself perform the encryption and decryption, or it may send it on to an additional specialized functionality in its application server or make use of a specialized tool or API that performs the method of the invention.

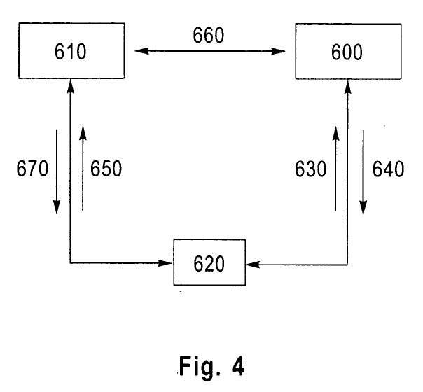

According to another embodiment, the invention may be characterized as a service as illustrated in the FIG. 4. The invention makes it possible for a service provider (600) to provide encrypted URIs as electronic tickets to certain resources that are provided separately by a resource provider entity (610). The resource provider entity may provide any kind of resource that is obtainable through the use of a URI, such as, for example, web pages, data files, music, images, streaming media, etc. The service provider (600), e.g., a broker or seller, may issue the electronic ticket for a fee or as part of a commercial offering on behalf of the resource provider entity (610). The electronic ticket may contain all the information that is needed for a resource to provide access and/or for a user to be granted access, including, for example, issue and validity time. The information may be included in the encrypted portion of the URI which, as will be recalled from the above description, may include additional information (e.g., 70, 310) pertaining to access control. Because this information is encrypted, it is hidden, tamper resistant, and it deters users or unauthorized entities from modifying it.

According to this embodiment of the invention, all the necessary information may be provided in the electronic ticket. Therefore, the issuer of the ticket (600) does not have to be connected with the web server (610) that grants access to the given resource. For example, a seller, broker or other service provider (600) may interact with a buyer (620) or user who purchases or otherwise requests (630) access to a particular resource or content available at the web server (610) of a content provider or resource provider. The service provider or broker may respond (640) to the request or purchase by providing a URI that is encrypted in accordance with the methods described above. The URI may be readily communicated (640) to the requester (620) via any one of a number of known methods, such as by serving a web page, or via e-mail, instant messaging, SMS, etc. The encrypted URI may include information granting access to one or more particular resources, at a particular time, according to a particular service level, and/or in a particular manner that may be tailored, for example, to a client device such as a wireless or pervasive computing device.

Upon receipt of a request (630) for access to resources at an external resource producer server (610), the service provider (600) (or “electronic ticket issuer”) may first determine whether any transactional requirements have been satisfied. Transactional requirements may pertain to payment and/or other requirements governing whether the requester (620) may access the service provider (600) and/or the resources at (610). For example, the service provider (600) may interact with the requester (620) to receive payment, or may determine if payment has been made or needs to be made for the requested access. Service provider (600) also includes one or more provisioning processes (not shown) which are used to provision client requests for resources and to store transaction details in a data store (not shown)

The electronic ticket issuer (600) may then use a predetermined key to create a URI with a predetermined structure that may subsequently be used by the client (620) to request (650) resources (670) at the resource provider (610). The predetermined keys used by the service provider (600) and the resource provider (610), can be either symmetric or asymmetric keys (see, e.g., keys 100 and 260 in FIGS. 1 and 2, respectively). Thus, if the service provider (600) issues (640) an encrypted URI to a requester (620), who subsequently uses the URI to seek access (650) to resources (670) at the resource producer server (610), the resource producer (610) may use the predetermined key to decrypt the URI.

The structure of the URI and encryption keys may be predetermined (660) by the service provider (600) and the resource producer (610), so that the resource producer may verify that certain requirements have been met. For example, the predetermined structure may include an indication that the requester has paid for access to the resources, or that the requester is at least age 18, or that the requester may obtain access to a resource during a specified time period, or that a particular service level has been specified, etc. The specifics of the key and structure are typically arranged (660) between the broker (600) and the resource provider (610) before the service provider (600) issues (640) electronic tickets to the requester (620). The predetermined structure of the URI may more generally include predetermined data supporting integrity, access control, session management, and/or application specific purposes.

Given a location to a protected resource, the service provider (600) creates an encrypted URI in accordance with the method of the invention as disclosed herein. The service provider (600) then sends or issues (640) the encrypted URI to the requester (620).

Upon receipt of the encrypted URI, a user (620) may select, click on or otherwise activate the URI, which provides a link to some desired content or resource available at the resource provider server (610). In accordance with this aspect of the invention, the web server (610) that grants access to the resource does not need to have a direct link with the service provider entity (600) that issues (640) the encrypted URI. The resource provider (610) may independently decrypt the URI, determine whether access may be granted, verify the information contained within the URI and/or optionally may encrypt URIs according to the inventive methods described above before serving (670) resources to a requester (620). For example, the resource provider (610) preferably uses a key or encryption or decryption scheme corresponding to the scheme used by the entity (600) that encrypts the URI, as discussed above. The broker or service provider (600) and the resource provider (610) may accordingly establish a service relationship (660) wherein the provision (640) of the electronic ticket is decoupled from the serving (670) of the resources.

In yet another embodiment, the invention may be used by a content provider server to support detection of robots or other intruders. Robots, for example, are used on the Internet by various entities to automate repetitive tasks such as browsing a website and downloading its content. As robots' behaviour is similar to that of other, regular users, their detection is difficult. The invention may be used by a content provider by encoding a hidden “taint” in its URIs to support robot detection. The taint is included in the URI that is encrypted in accordance with the invention, thereby making it possible to correlate multiple requests originating from the same web page, even if the client uses multiple IP addresses.

In a further embodiment, the inventive methods may be used to add tamper proof parameters to a URI. A useful parameter to add to a URI is the expiry time of the requested resources. By encrypting parameters that are added to a URI, a resource provider may give a customer access to some content for a limited amount of time. If a requester uses the URI with the encrypted parameters in an attempt to access the resource after the expiry time or date has passed, the method of the invention may be used to decrypt the URI parameters, perform validation checking thereof, and deny access. Optionally, the resource provider server may redirect the requester to an alternative web page giving the requester the opportunity to buy longer access.

The invention may also be used to help ensure fair use of resources served in a controlled manner using the URI encryption methods of the invention. For example, if a customer purchases access to some resources, e.g., an online dictionary or game, the customer is provided a URI that is used to locate and access the resources. Using the inventive methods, the customer's IP address may be added to the encrypted portion of the URI. By issuing the URI in this manner, a resource provider may prevent the customer from sharing his or her access with other, non-paying users, since the access is granted only to requests coming from the IP address embedded within the encrypted portion of the URI.

Additionally, since the invention may be used to hide the directory structure that is typically apparent in URIs, the invention deters users from guessing URIs and instead requires users to use hyperlinks. Furthermore, if a resource provider wishes to prevent users from blocking content such as advertisements, the invention may be used to accomplish this. An encrypted URI looks random and therefore prevents unwanted use or tampering of the logical structure for selective content blocking. Additionally, since the encrypted URI is stateless it may be used in a server under extremely high load, such as, e.g., a web server for a major sports event.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive); or downloaded via the Internet or other computer network; or distributed via any transmission-type media, such as digital analog communications links, wired or wireless communications links using transmission forms, such as, for example, radio frequency and light wave transmissions. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Furthermore, it will be apparent to those of skill in the art that the methods of the invention may be executed by an article of manufacture comprising a machine readable medium containing one or more programs. In addition, it will be apparent that the invention describes a method that may be performed by data communication network components on behalf of parties such as, for example, content or service providers, content or service requesters, brokers and/or intermediaries.

The description of the present invention has been presented for purposes of illustration and description and is not intended to be exhaustive or limited to the invention in the form disclosed. Many modifications and variations may be effected by one skilled in the art without departing from the scope or spirit of the invention. The illustrations of the preferred embodiment were chosen and described in order to best explain the principles of the invention, the practical application, and to enable others of skill in the art to understand the invention for various embodiments with various modifications as are suited to the particular use contemplated.

1. A method for providing controlled access to resources at a resource provider server, the method comprising:
responsive to a resource request from a client, wherein the resource request comprises a uniform resource identifier (URI) having an encrypted portion,
decrypting the encrypted portion using a predetermined key to obtain a decrypted segment;
extracting additional information from the decrypted segment;
verifying the additional information;
deriving a decrypted URI with at least a portion of the decrypted segment; and
forwarding the decrypted URI to a resource producer server.

2. The method of claim 1, wherein the additional information comprises data supporting at least one of integrity, access control, session management and application specific purposes.

3. The method of claim 1, wherein verifying the additional information comprises comparing access control details contained in the additional information with access control data stored in a data store.

4. The method of claim 1, further comprising verifying the encrypted portion.

5. The method of claim 1, further comprising decoding the encrypted portion.

6. The method of claim 1, further comprising:
receiving, from a resource producer server, a resource responsive to the request, wherein the resource comprises one or more unencrypted URIs having a transparent segment and an opaque segment;
encrypting at least a portion of the opaque segment; and
forming an encrypted URI with the transparent segment and the encrypted portion.

7. The method of claim 6, further comprising forming a combined segment from the opaque segment and other additional information and encrypting the combined segment to form the encrypted portion.

8. The method of claim 7, wherein the other additional information comprises data supporting at least one of integrity, access control, session management and application specific purposes.

9. The method of claim 6, further comprising forwarding the encrypted URI to the client.

10. The method of claim 6, further comprising encoding the encrypted portion.

11. A computer program product stored in a computer operable media for controlling access to a resource producer server comprising:
a storage medium;
instructions for receiving a uniform resource identifier (URI) comprising a transparent portion and an encoded encrypted portion;
instructions for extracting the encoded encrypted portion;
instructions for decoding the encoded encrypted portion to obtain an encrypted segment;
instructions for decrypting the encrypted segment using a predetermined key to obtain a decrypted segment:
instructions for extracting additional information from the decrypted segment; and
instructions for verifying the additional information.

12. The computer program product of claim 11, further comprising instructions for producing a second URI derived from at least one of the transparent portion and the decrypted segment.

13. The computer program product of claim 12, further comprising instructions for forwarding the second URI to an application program associated with the resource producer server.

14. The computer program product of claim 11, further comprising:
instructions for receiving a resource comprising one or more unencrypted URIs having a transparent segment and an opaque segment;
instructions for encrypting data derived from at least one of the transparent portion and the opaque segment;
instructions for encoding the encrypted data; and
instructions for forming an encrypted URI with the transparent segment and the encoded encrypted data.

15. The computer program product of claim 14, further comprising instructions for forwarding the encrypted URI to a client.

16. A program storage device readable by machine, tangibly embodying a program of instructions executable by the machine to perform a method for providing controlled access to resources at a resource provider server, the method comprising:
obtaining a uniform resource identifier (URI) having an encrypted portion,
decrypting the encrypted portion using a predetermined key to obtain a decrypted segment;
extracting additional information from the decrypted segment;
verifying the additional information;
forming a decrypted URI with at least a portion of the decrypted segment; and
forwarding the decrypted URI to a resource producer server.

17. The program storage device of claim 16, wherein the method further comprises comparing access control details contained in the additional information with access control data stored in a data store.

18. The program storage device of claim 16, wherein the method further comprises verifying the encrypted portion.

19. The program storage device of claim 16, wherein the method further comprises decoding the encrypted portion.

20. The program storage device of claim 16, wherein the method further comprises:
obtaining, from a resource producer server, a resource comprising one or more unencrypted URIs having a transparent segment and an opaque segment;
encrypting at least a portion of the opaque segment; and
forming an encrypted URI with the transparent segment and the encrypted portion.

21. A method of providing a service enabling controlled access to an external resource producer server comprising:
responsive to a request from a client for access to a resource, determining whether one or more transactional requirements are satisfied;
if the one or more transactional requirements are satisfied, creating a uniform resource identifier (URI) responsive to the request, wherein the URI includes predetermined data in a predetermined structure;
encrypting at least a portion of the URI; and
sending the URI with the encrypted portion in response to the request.

22. The method of claim 21, further comprising storing transaction details pertaining to the request in a data store.

23. The method of claim 21, further comprising encoding the encrypted portion of the URI.

24. The method of claim 21, further comprising separately communicating the predetermined data and the predetermined structure to the external resource producer.

25. The method of claim 21, further comprising communicating transactional details pertaining to resource requests to the external resource producer to obtain payment.

26. The method of claim 21, wherein the one or more transactional requirements comprises payment from the client.

27. The method of claim 21, wherein the one or more transactional requirements comprises determining whether the client satisfies one or more access requirements.

28. The method of claim 21, wherein determining whether one or more transactional requirements are satisfied comprises comparing access control details contained in the request with access control data stored in a data store.

29. The method of claim 21, wherein the URI with the encrypted portion is an electronic ticket.

30. The method of claim 21, wherein the predetermined data comprises data supporting at least one of integrity, access control, session management and application specific purposes.
